(19) United States
(12) Patent Application Publication
(10) Pub. No.: US 2008/0017222 A1
(43) Pub. Date: Jan. 24, 2008

(54) SUBSTRATE PROCESSING APPARATUS AND SUBSTRATE PROCESSING METHOD

(76) Inventors: Katsuhiko Miya, Kyoto (JP); Akira Izumi, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/770,276

(22) Filed: Jun. 28, 2007

(30) Foreign Application Priority Data
Jul. 18, 2006 (JP) 2006-195026

(51) Int. Cl. B08B 3/08; B08B 5/04

(52) U.S. Cl. 134/21; 134/116; 134/95.1

(57) ABSTRACT

Above a wafer which is held by a spin chuck, a blocking member whose opposed surface to the wafer is approximately horizontal is disposed at a higher position than an organic solvent component supplying outlet which is able to move from a central position of the wafer toward the periphery of the wafer. An organic solvent component nozzle scans (moves) together with the blocking member, thereby efficiently supplying a gas containing an organic solvent component discharged from the organic solvent component supplying outlet onto a surface of the wafer without getting discharged from the vicinity of the surface of the wafer owing to the blocking member. Hence, when the organic solvent component nozzle scans (moves), the concentration of the organic solvent component is always high near the organic solvent component supplying outlet.

### CROSS REFERENCE TO RELATED APPLICATION

The disclosure of Japanese Patent Application No. 2006-195026 filed Jul. 18, 2006 including specification, drawings and claims is incorporated herein by reference in its entirety.

### BACKGROUND OF THE INVENTION

1. Field of the Invention

The present invention relates to a substrate processing apparatus for and a substrate processing method of drying a substrate to which a liquid adheres. The present invention particularly relates to a substrate processing apparatus and a substrate processing method which, in a single wafer processing, dry a substrate after rinsing processing is performed. Substrates to be dried include, for example, semiconductor wafers, substrates for liquid crystal display, substrates for plasma display, substrates for FED (Field Emission Display), substrates for optical disks, substrates for magnetic disks, substrates for magnet-optical disks, substrates for photomask, etc.

2. Description of the Related Art

Manufacturing steps of fabricating a semiconductor device include processing with supply of a processing liquid (which is chemical solution or deionized water) to a surface of a semiconductor wafer (hereinafter simply referred to as the “wafer”) which serves as a substrate-to-be-processed. Particularly in a substrate cleaning apparatus for cleaning a wafer, a chemical solution for cleaning processing is supplied to a surface of a wafer, and deionized water is thereafter supplied, whereby rinsing is performed. Since deionized water adheres to thus rinsed wafer surface, drying is executed to remove the deionized water.

Known as one of drying methods to this end is a drying method which utilizes Marangoni effect. This drying method is a method of drying a wafer by means of a convective flow (Marangoni convective flow) generated due to a difference in surface tension. Known particularly for a substrate processing apparatus of a single water processing is so-called Rotagoni drying which is a combination of spin drying and drying processing which utilizes Marangoni effect.

During Rotagoni drying, IPA (isopropyl alcohol) vapor and deionized water are blown toward a rotating wafer from associated nozzles, respectively, from above the center of the wafer. Due to this, drying starts at a section which receives the blown IPA vapor, a dried area spreads from the center of the wafer toward the periphery of the wafer, and the entire surface of the wafer dries. In other words, the deionized water on the wafer is removed from the wafer owing to the action of centrifugal force which develops with the rotation of the wafer and Marangoni effect attributable to blow of IPA vapor, whereby the wafer is dried.

On the other hand, patterns formed on a surface of a wafer have rapidly become increasingly finer over the recent years, and a new problem during drying of the wafer has arisen with this fine patterns. To be more specific, a problem has occurred that patterns collapse when deionized water which has entered into inside between patterns formed on the wafer dries up. Such pattern destruction is considered to be because of different pressures inside space between patterns which develop owing to different distances between patterns during drying of deionized water which has entered into inside between patterns. It is possible to decrease the differences of pressure inside between patterns by reducing the surface tension of the deionized water which has entered into inside between patterns, and to prevent pattern destruction.

For prevention of pattern destruction, it is therefore effective to replace deionized water which has entered into inside between patterns with IPA vapor whose surface tension is low and to dry a wafer in the manner described above (JP-A-2003-197590 and JP-A-9-293702, for instance).

According to JP-A-2003-197590, after rinsing of a wafer with deionized water, while supplying IPA vapor to a rinsed section from an IPA vapor nozzle, the IPA vapor nozzle moves outward in the radial direction of the wafer. This dissolves the IPA vapor in the deionized water which adheres to the wafer and reduces the surface tension of the deionized water which has entered into inside between patterns, thereby attaining drying while preventing pattern destruction to a certain extent.

According to JP-A-9-293702, a disk-like dry guide covers the top or bottom surface of a rotating wafer which is held horizontally, and after the space between the wafer and the dry guide is filled up with rinsing deionized water, vapor of IPA is supplied to the top or bottom surface of the wafer from a supplying outlet of the dry guide. This forms an air-liquid interface concentrically whose center is the center of the rotating wafer, and due to Marangoni effect attributable to a difference of surface tension at the interface, the wafer is dried.

### SUMMARY OF THE INVENTION

However, since IPA vapor supplied onto the wafer quickly leaves the wafer owing to an air flow which develops by the rotation of the wafer according to the IPA vapor supplying method described in JP-A-2003-197590, it is not easy to dissolve IPA in deionized water which adheres to the wafer and it is not possible to fully enjoy the effect of prevention of pattern destruction.

Meanwhile, although the air flow which develops by the rotation of the wafer is prevented from pushing away IPA vapor from above the wafer since the dry guide covers the top or bottom surface of the wafer according to the IPA vapor supplying method described in JP-A-9-293702, since the supplying outlet for supplying IPA vapor to the wafer is located at a fixed position, when rinsing deionized water moves to the periphery with the rotation of the wafer, it becomes impossible to always feed IPA vapor to an area close to the location of the air-liquid interface and hence it is difficult to control the air-liquid interface. This gives rise to a problem that the speed at which the air-liquid interface moves slows down and the drying speed of the wafer accordingly slows down.

An object of the invention is to provide a substrate processing apparatus and a substrate processing method with which it is possible to efficiently dry a substrate while adequately preventing pattern destruction.

According to a first aspect of the present invention, there is provided a substrate processing apparatus, comprising: a substrate holder which rotates a substrate while holding the substrate approximately horizontally; an organic solvent component supplying mechanism which includes an organic solvent component supplying outlet for supplying a gas containing an organic solvent component to the substrate which is held by the substrate holder and of which a liquid film of a rinsing liquid for washing away residuals adhering to the substrate is formed on a top surface; a moving mechanism which moves the organic solvent component supplying outlet from an approximate rotation center of the substrate which is held by the substrate holder toward a periphery of the substrate; and a blocking member which is disposed above the organic solvent component supplying outlet, moves, driven by the moving mechanism, together with the organic solvent component supplying outlet, and blocks off an atmosphere above the organic solvent component supplying outlet.

According to a second aspect of the present invention, there is provided a substrate processing method, comprising: a substrate holding step of holding a substrate approximately horizontally and rotating the substrate; a liquid film forming step of supplying a rinsing liquid to the substrate and forming a liquid film of the rinsing liquid on a top surface of the substrate; and an organic solvent component supplying step, which is executed after the liquid film forming step, of supplying a gas which contains an organic solvent component to the substrate and moving a supplying position at which the gas containing the organic solvent component is supplied to the top surface of the substrate from an approximate rotation center of the substrate toward the periphery of the substrate, wherein at the organic solvent component supplying step, a blocking member blocks off an atmosphere above the supplying position at which the gas containing the organic solvent component is supplied to the top surface of the substrate.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a schematic cross sectional view which shows a structure of a substrate processing apparatus according to a first embodiment of the invention.

FIG. 2 is a top plan view of the spin chuck.

FIG. 3 is a top view of the organic solvent component nozzle.

FIG. 4 is a block diagram for describing an electric structure of this substrate processing apparatus.

FIG. 5 is a flow chart of the processing operation performed to the wafer in this substrate processing apparatus.

FIG. 6 is a schematic side view for describing the structure of a substrate processing apparatus according to a second embodiment of the invention.

FIG. 7 is a schematic top plan view showing the vicinity of the organic solvent component nozzle.

FIG. 8 is a schematic side view showing a modification of the rinse nozzle.

FIGS. 9 and 10 are schematic top plan views of the blocking member for illustrating other embodiments.

### DETAILED DESCRIPTION OF THE PREFERRED EMBODIMENTS

A first embodiment of the invention will now be described in detail with reference to the associated drawings.

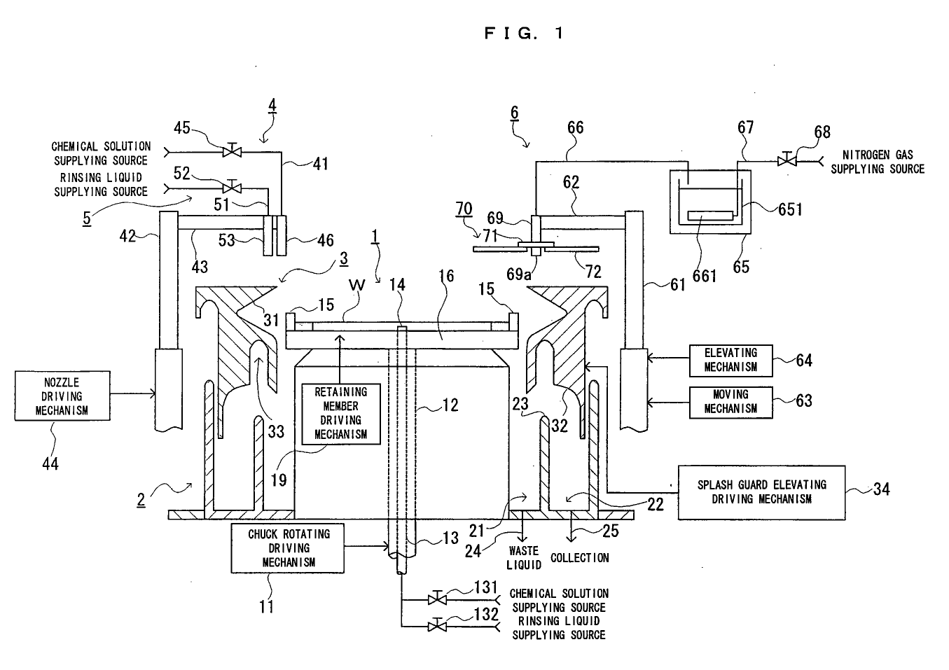

FIG. 1 is a schematic cross sectional view which shows a structure of a substrate processing apparatus according to the first embodiment of the invention. This substrate processing apparatus is a cleaning and drying apparatus which cleans semiconductor wafers (hereinafter referred to as “wafers”) W serving as substrates one by one and dries thus cleaned wafers W. This substrate processing apparatus comprises a spin chuck 1, a processing cup 2 which houses the spin chuck 1, a splash guard 3 which is disposed in relation to the processing cup 2, a chemical solution supplying mechanism 4, a chemical solution and a rinsing liquid supplying mechanism 5, and an organic solvent component supplying mechanism 6. The spin chuck 1 holds the wafer W approximately horizontally and rotates the wafer W about the axis line of rotation which penetrates the center of the wafer approximately vertically. The chemical solution supplying mechanism 4 is for supplying a chemical solution to a surface (top surface) of the wafer W which is held by the spin chuck 1. The rinsing liquid supplying mechanism 5 is for supplying a rinsing liquid to the surface of the wafer W which is held by the spin chuck 1. The organic solvent component supplying mechanism 6 is for supplying a gas which contains an organic solvent component to the surface of the wafer W which is held by the spin chuck 1.

The spin chuck 1 comprises a disk-shaped spin base 16, a rotation shaft 12 which is disposed in the vertical direction and whose top end is fixed to the bottom surface of the spin base 16, and a chuck rotation driving mechanism 11 which rotates the rotation shaft 12 and the spin base 16. The rotation shaft 12 is a hollow shaft. A chemical solution/rinsing liquid supplying pipe 13 which selectively supplies a chemical solution or a rinsing liquid is inserted inside the rotation shaft 12. To the chemical solution/rinsing liquid supplying pipe 13, the chemical solution is supplied from a chemical solution supplying source via a valve 131 and the rinsing liquid is supplied from a rinsing liquid supplying source via a valve 132. The chemical solution/rinsing liquid supplying pipe 13 extends to a position which is in the vicinity of the wafer W which is held by the spin chuck 1, and at the tip end of the chemical solution/rinsing liquid supplying pipe 13, a back surface nozzle 14 is formed which discharges the chemical solution or the rinsing liquid toward the center of the bottom surface of the wafer W.

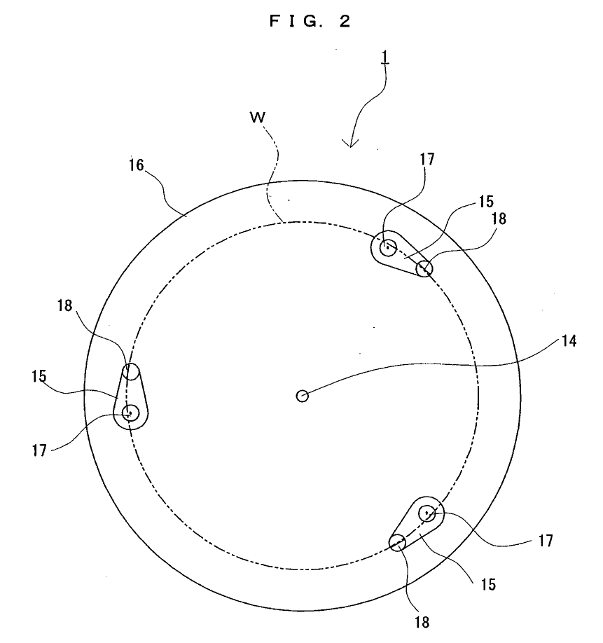

FIG. 2 is a top plan view of the spin chuck 1. Three retaining members 15 for instance are disposed equidistantly in a peripheral edge section of the spin base 16. Each retaining member 15 has a support part 17 which supports the bottom surface of the periphery of the wafer W with a point contact and a retaining part 18 which abuts on the outer circumferential edge surface of the wafer W, and is structured to revolve about a vertical axis line with the support part 17 as the center. In this manner, each retaining member 15 can be in a retaining state that the retaining part 18 abuts on the outer circumferential edge surface of the wafer W and a released state that the retaining part 18 has backed off from the outer circumferential edge surface of the wafer W. A retaining member driving mechanism 19 (FIG. 1) drives these three retaining members 15 in synchronization to each other.

In this manner, while this embodiment uses the spin chuck 1 described above as the “substrate holder” of the invention, the “substrate holder” may be a vacuum-chuck type spin chuck which sucks and supports the bottom surface of the wafer W in the case where the bottom surface of the wafer W needs not be cleaned.

The processing cup 2 is formed in a shape of a cylinder which has a bottom. A draining groove 21 for draining the rinsing liquid or the like after use for processing of the wafer W is formed in the bottom section of the processing cup 2 so as to surround, viewed from the top, the spin chuck 1. Further, a collection groove 22 for collecting the chemical solution after use for processing of the wafer W is formed in the bottom section of the processing cup 2 so as to surround the draining groove 21. A cylindrical partition wall 23 separates the draining groove 21 and the collection groove 22 from each other. Further, a draining line 24 extending to a waste liquid treatment installation not shown is connected to the draining groove 21, whereas a collection line 25 extending to a collection treatment installation not shown is connected to the collection groove 22.

The shape of the splash guard 3 is approximately rotational-symmetric to the axis line of rotation of the wafer W. The inner surface of the upper section of the splash guard 3 serves as a waste liquid capture part 31 which opens facing the axis line of rotation of the wafer W and of which the surface is V-shaped in a cross sectional view. Further, in a lower section of the splash guard 3, a collected liquid capture part 32 is provided which has an inclined surface which tilts down with a distance toward outside in a radial direction of the wafer W. Near the top end of the collected liquid capture part 32, there is a partition wall housing groove 33 which accepts the partition wall 23 of the processing cup 2.

In relation to the splash guard 3, a splash guard elevating driving mechanism 34 is disposed which for instance includes a ball screw mechanism, etc. The splash guard elevating driving mechanism 34 moves the splash guard 3 up and down between a collection position at which the collected liquid capture part 32 is opposed to the edge surface of the wafer W which is held by the spin chuck 1 and a draining position at which the waste liquid capture part 31 is opposed to the edge surface of the wafer W which is held by the spin chuck 1. Further, the splash guard elevating driving mechanism 34 makes the splash guard 3 retract to a retract position which is below the draining position during loading and unloading of the wafer W to and from the spin chuck 1.

The chemical solution supplying mechanism 4 comprises a chemical solution nozzle 46 which supplies a continuous flow of the chemical solution to the surface of the wafer W, a chemical solution supplying pipe 41 which supplies the chemical solution to the chemical solution nozzle 46 from the chemical solution supplying source, and a valve 45 which is inserted in the chemical solution supplying pipe 41 to open and close the chemical solution supplying pipe 41. Further, a revolving shaft 42 is disposed outside the processing cup 2 which extends in the vertical direction, and the chemical solution nozzle 46 is attached to the tip end of an arm 43 which extends approximately horizontally from the top end of the revolving shaft 42. A nozzle driving mechanism 44, which revolves the revolving shaft 42 about a central axis line within a predetermined angle range, is linked to the revolving shaft 42. When driving power is transmitted to the revolving shaft 42 from the nozzle driving mechanism 44 and revolves the revolving shaft 42 within the predetermined angle range, the chemical solution nozzle 46 moves between a chemical solution supplying position which is above the wafer W which is held by the spin chuck 1 and a retract position which is off from above the wafer W.

A chemical solution which is suitable to the content of a processing to the surface of the wafer W is used as the chemical solution. For example, in the case of resist stripping processing for stripping an unwanted resist film off from the surface of the wafer W, a resist stripper such as SPM (mixture of sulfuric acid and hydrogen peroxide) may be used. Further, in the case of polymer removing processing after resist stripping processing to remove a resist residue which remains as a polymer on the surface of the wafer W, a polymer removing liquid such as APM (mixture of ammonia and hydrogen peroxide) may be used. Further, in the case of etching to remove an oxidized film formed on the surface of the wafer W, a hydrofluoric acid may be used.

The chemical solution/rinsing liquid supplying mechanism 5 comprises a rinse nozzle 53, a rinsing liquid supplying pipe 51, and a valve 52. The rinse nozzle 53 is disposed next to the chemical solution nozzle 46 at the tip end of the arm 43. The rinsing liquid supplying pipe 51 is connected to the rinse nozzle 53 and supplies the rinsing liquid to the rinse nozzle 53 from a rinsing liquid supplying source. The valve 52 is inserted in the rinsing liquid supplying pipe 51 to open and close the rinsing liquid supplying pipe 51. When driving power is transmitted to the revolving shaft 42 from the nozzle driving mechanism 44 and pivots the arm 43, the rinse nozzle 53 moves between a rinsing liquid supplying position which is above the wafer W which is held by the spin chuck 1 and a retract position which is off from above the wafer W.

Although the chemical solution nozzle 46 and the rinse nozzle 53 are both attached to the arm 43 and move when driven by the nozzle driving mechanism 44 in this embodiment, the chemical solution nozzle 46 and the rinse nozzle 53 may be attached to separate arms and two driving mechanisms may be disposed. Further, in this embodiment, the chemical solution nozzle 46 and the rinse nozzle 53 are structured so that they can move between their supplying positions which are above the wafer W and their retract positions which are off from above the wafer W. However, the chemical solution nozzle or the rinse nozzle may be disposed at a position above the wafer W such that it can ascend and descend, and may supply the chemical solution or the rinsing liquid toward a central position of the wafer W.

The rinsing liquid for washing away the residual (chemical solution) adhering to the wafer W may be deionized water for instance. Other than deionized water, the rinsing liquid may be functional water such as carbonated water, electrolytic ionized water, hydrogen water and magnetized water, or may be diluted ammonia water (having the concentration of around 1 ppm for instance), diluted hydrochloric acid, etc.

The organic solvent component supplying mechanism 6 comprises an organic solvent component nozzle 69, a production unit 65, and a supplying pipe 66. The organic solvent component nozzle 69 supplies, from an organic solvent component supplying outlet 69a, IPA (isopropyl alcohol) vapor as a gas which contains an organic solvent component to the surface of the wafer W. The production unit 65 generates the gas which contains the organic solvent component. The supplying pipe 66, with its one end connected to the organic solvent component nozzle 69 and its other end connected to the production unit 65, supplies the gas which contains the organic solvent component generated by the production unit 65 to the organic solvent component nozzle 69. The organic solvent component nozzle 69 is fixed to the tip end of an arm 62 which extends approximately horizontally from the top end of a revolving shaft 61 which is disposed outside the processing cup 2 in the vertical direction. Further, the organic solvent component nozzle 69 is attached to the arm 62 so that it lies parallel to the perpendicular line to the surface of the wafer W and discharges from the organic solvent component supplying outlet 69a the gas containing the organic solvent component fed from the supplying pipe 66 toward below approximately in the vertical direction.

A reservoir tank 651 which stores an organic solvent liquid (liquid IPA in this embodiment) is installed inside the production unit 65, and the atmosphere inside the production unit 65 contains the organic solvent component (IPA) evaporated from the reservoir tank 651. Further, the tip end of a nitrogen gas pipe 67, which extends from a nitrogen gas supplying source which is a utility available in a plant, is connected to the production unit 65. The tip end of the nitrogen gas pipe 67 is connected to a bubbler 661 which is disposed at the bottom of the reservoir tank 651 inside the reservoir tank 651. The bubbler 661 is structured with a hollow duct which has plural holes, and gushes out nitrogen gas. A valve 68 is inserted in the nitrogen gas pipe 67 to open and close the nitrogen gas pipe 67. In this structure, when the valve 68 is opened and the nitrogen gas is fed into inside the production unit 65 from the nitrogen gas pipe 67 via the bubbler 661 at a predetermined flow rate (which may for instance be 5 L/min), the liquid inside the reservoir tank 651 bubbles up and the nitrogen gas pushes out the atmosphere containing the organic solvent component within the production unit 65 into the supplying pipe 66, whereby the atmosphere is supplied to the organic solvent component nozzle 69 through the supplying pipe 66. The nitrogen gas which contains the organic solvent component (IPA) is thus supplied to the organic solvent component nozzle 69 in this structure. In other words, the nitrogen gas which is an inert gas transports the organic solvent component, serving as a carrier gas.

Although this embodiment uses IPA vapor as the gas which contains the organic solvent component, the gas is not limited to IPA vapor but may instead be vapor of an organic solvent which is soluble in the rinsing liquid, decreases the surface tension of the rinsing liquid and is highly volatile. For example, ethanol, methanol, acetone or the like may be used instead of IPA.

A moving mechanism 63 transmits driving power to the revolving shaft 61 and accordingly revolves the revolving shaft 61 within the predetermined angle range, whereby the arm 62 is pivoted above the wafer W which is held by the spin chuck 1. With this, a supplying position of the gas which contains the organic solvent component from the organic solvent component supplying outlet 69a scans (moves) above the surface of the wafer W which is held by the spin chuck 1, and moves to a retract position which is off from above the wafer W, when the gas which contains the organic solvent component is not supplied to the wafer W. Further, an elevating mechanism 64 is provided which moves the arm 62 upward and downward. The revolving shaft 61 and the arm 62 ascend and descend by the elevating mechanism 64, which changes the distance between the organic solvent component supplying outlet 69a and the surface of the wafer W.

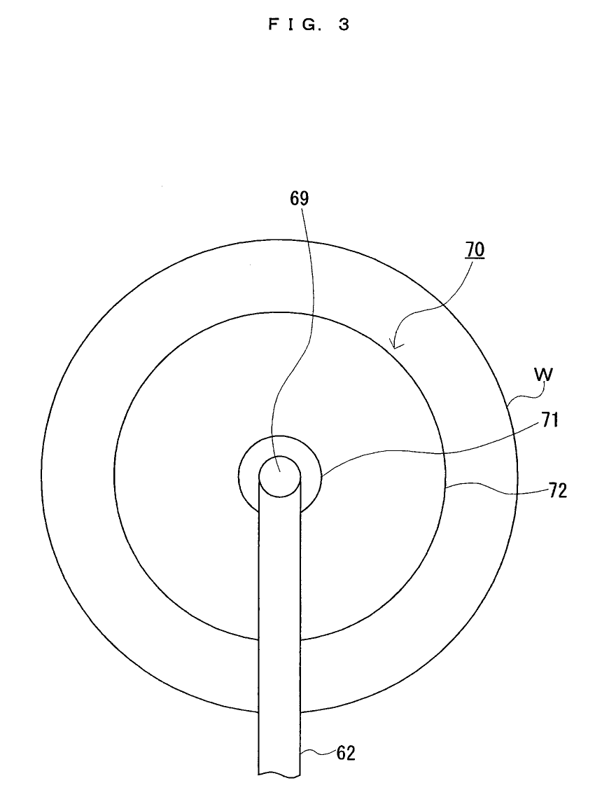

FIG. 3 is a top view of the organic solvent component nozzle 69. A blocking member 70, whose opposed surface to the wafer W is approximately horizontal, is disposed at a position above the organic solvent component supplying outlet 69a. The blocking member 70 comprises a support part 71 which is fixed to a side wall around the organic solvent component nozzle 69 and a plate member 72 which is fixed to the support part 71 and is shaped like a circular disc with the organic solvent component nozzle 69 at the approximate center. At least the sections of the support part 71 and the plate member 72 which are exposed to the organic solvent component are made of a material which are resistant to the chemical solution such as PVC (polyvinyl chloride) and a fluorine resin for instance. In addition, the support part 71 and the plate member 72 may be formed separately from each other or may be molded as one integrated structure. Further, it is preferable that the size of the plate member 72 is the same at least as (that is, not smaller than) that of a liquid film of the rinsing liquid which is pushed away off from the top surface of the wafer W by the gas which contains the organic solvent component at the time of discharge of the gas containing the organic solvent component from the organic solvent component supplying outlet 69a toward the liquid film of the rinsing liquid formed on the top surface of the wafer W.

In this embodiment, a nitrogen gas is supplied at the flow rate of 5 L/min to the inside of the production unit 65, the atmosphere containing the organic solvent component inside the production unit 65 is pushed out into the supplying pipe 66, and the gas containing the organic solvent component is supplied from the organic solvent component nozzle 69 through the supplying pipe 66. At this stage, the gas containing the organic solvent component pushes away the liquid film of the rinsing liquid of the area of a circle whose diameter is about 50 mm to about 80 mm with the organic solvent component supplying outlet 69a at the center. It is therefore preferable that the size of the plate member 72 is the same as or larger than (that is, not smaller than) the range of thus pushed away rinsing liquid film (that is, a circle whose diameter is about 50 mm to about 80 mm), and in this embodiment, the plate member 72 has a diameter of about 200 mm. Further, although the plate member 72 is shaped like a circular disc in a top plan view in this embodiment, the shape is not limited to a circular disc but may be oval, rectangular or the like.

The blocking member 70 is scanned together with the organic solvent component nozzle 69. Due to the existence of the blocking member 70, the gas containing the organic solvent component discharged from the organic solvent component supplying outlet 69a is intensively supplied to the vicinity of the surface of the wafer W without getting dispersed from the vicinity of the surface of the wafer W. Hence, even though the organic solvent component nozzle 69 is scanned, the concentration of the organic solvent component is maintained always high in the vicinity of the organic solvent component supplying outlet 69a.

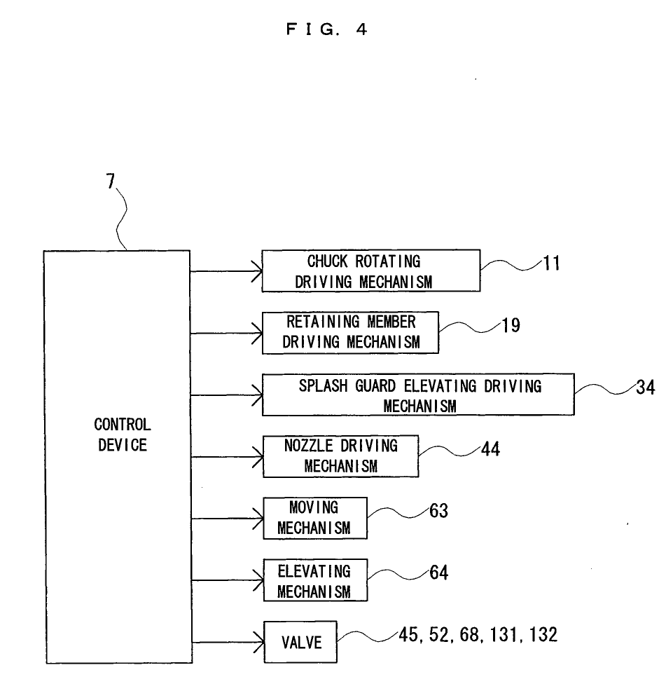

FIG. 4 is a block diagram for describing an electric structure of this substrate processing apparatus. This substrate processing apparatus comprises a control device 7 which consists of a microcomputer for instance. The control device 7 controls the operations of the chuck rotating driving mechanism 11, the retaining member driving mechanism 19, the splash guard elevating driving mechanism 34, the nozzle driving mechanism 44, the moving mechanism 63 and the elevating mechanism 64. The control device 7 further controls opening and closing of the valves 45, 52, 68, 131 and 132.

Next, the processing operation performed to the wafer W in the substrate processing apparatus will now be described.

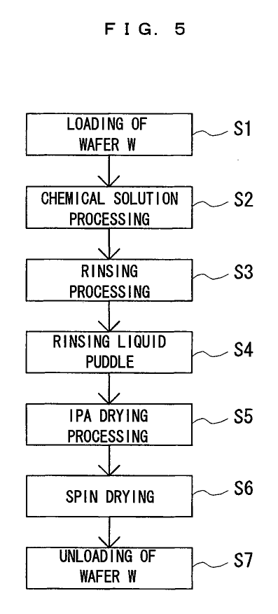

FIG. 5 is a flow chart of the processing operation performed to the wafer W in this substrate processing apparatus.

Meanwhile, in this embodiment, deionized water is used as the rinsing liquid, and IPA vapor in which a nitrogen gas serves as a carrier gas is used as the gas containing the organic solvent component.

Before processing to the wafer W is started, the control device 7 stops the chuck rotating driving mechanism 11, thereby holding the spin chuck 1 in halt, and controls the retaining member driving mechanism 19, thereby putting the retaining members 15 in a released state. Further, in order to secure uninterrupted loading of the wafer W, the control device 7 controls the splash guard elevating driving mechanism 34 and accordingly makes the splash guard 3 retract to the retract position. The valves 45, 52, 68, 131 and 132 are all closed. A substrate transportation robot (not shown) then loads the unprocessed wafer W onto the spin chuck 1. The control device 7, controlling the retaining member driving mechanism 19, makes the retaining parts 18 of the retaining members 15 abut on the outer circumferential edge surface of the wafer W to be in a retaining state (Step S1).

Next, the control device 7 controls the splash guard elevating driving mechanism 34 so that the splash guard 3 moves to the collection position at which the collected liquid capture part 32 is opposed to the edge surface of the wafer W. Further, the control device 7 controls the chuck rotating driving mechanism 11 so that the spin chuck 1 starts rotating. In addition, controlling the nozzle driving mechanism 44, the control device 7 makes the arm 43 pivot so that the chemical solution nozzle 46 is positioned above the central position of the wafer W which is on the spin chuck 1. When the spin chuck 1 reaches a predetermined velocity (500 to 700 rpm for instance), the valves 45 and 131 are opened and the chemical solution is supplied from the chemical solution nozzle 46 and the back surface nozzle 14 onto the central position of the wafer W. The chemical solution supplied to the central position of the wafer W, due to centrifugal force which develops by the rotation of the wafer W, spreads toward the periphery of the wafer W and is supplied to the entire surface of the wafer W. A chemical cleaning step is performed in this way (Step S2).

The chemical solution spreading toward the periphery of the wafer W at this chemical cleaning step is thrown off from the periphery of the wafer W to the side and caught by the collected liquid capture part 32 of the splash guard 3. Running down the collected liquid capture part 32, the chemical solution falls off at the bottom edge of the collected liquid capture part 32 into the collection groove 22 of the processing cup 2. The chemical solution thus flowing into the collection groove 22 is recollected via the collection line 25 and reused. After execution of the chemical cleaning step for a predetermined period of time (60 sec for instance), the valves 45 and 131 are closed and supply of the chemical solution from the chemical solution nozzle 46 and the back surface nozzle 14 is stopped.

The control device 7 then controls the splash guard elevating driving mechanism 34 so that the splash guard 3 moves to the draining position. Further, controlling the nozzle driving mechanism 44, the control device 7 makes the arm 43 pivot so that the rinse nozzle 53 is positioned above the central position of the wafer W. In addition, the control device 7 controls the chuck rotating driving mechanism 11 and accordingly rotates the spin chuck 1 at a predetermined velocity (300 to 700 rpm for instance). Then, the valves 52 and 132 are opened and the rinse nozzle 53 and the back surface nozzle 14 supply deionized water to the central position of the wafer W. The deionized water supplied to the central position of the wafer W spreads toward the periphery of the wafer W due to centrifugal force which develops by the rotation of the wafer W, and is supplied to the entire surface of the wafer W. A rinsing step is executed in this way (Step S3).

The deionized water spreading toward the periphery of the wafer W at this rinsing step is thrown off from the periphery of the wafer W to the side and caught by the waste liquid capture part 31 of the splash guard 3. Running down the waste liquid capture part 31, the deionized water falls off at the bottom edge of the waste liquid capture part 31 into the draining groove 21 of the processing cup 2. The deionized water thus flowing into the draining groove 21 is disposed via the waste liquid line 24. After execution of the rinsing step for a predetermined period of time (40 sec for instance), the control device 7 controls the chuck rotating driving mechanism 11 so that the rotating velocity of the wafer W gradually slows down and the wafer W stops rotating. This results in retention of deionized water supplied from the rinse nozzle 53 on the surface of the wafer W and formation of a liquid film of the deionized water which covers the entire surface of the wafer W (Step S4). When the liquid film is formed, the control device 7 closes the valves 52 and 132, thereby stopping supply of deionized water to the surface of the wafer W from the rinse nozzle 53 and the back surface nozzle 14. Further, the control device 7 controls the nozzle driving mechanism 44 and makes the rinse nozzle 53 retract from the position above the wafer W.

Next, the control device 7 controls the moving mechanism 63, thereby pivoting the arm 62 so that the organic solvent component supplying outlet 69a comes to a position above the central position of the wafer W, and controls the elevating mechanism 64, thereby ensuring a distance of 10 mm to 20 mm between the surface of the wafer W and the opposed surface of the blocking member 70 opposed to the wafer W for instance. Further, controlling the chuck rotating driving mechanism 11, the control device 7 makes the spin chuck 1 rotate at a predetermined velocity (10 to 100 rpm for instance). Following this, the control device 7 opens the valve 68 and controls the moving mechanism 63 to move the arm 62 at a constant speed (which may for example be a speed of traveling in about 30 seconds from the central position of the wafer W to the outer circumference of the wafer W) so that the organic solvent component nozzle 69 moves toward outside the wafer W. IPA vapor is thus supplied from the organic solvent component supplying outlet 69a to the surface of the wafer W which is rotating at a low speed. And the supplying position of IPA vapor gradually moves from the vicinity of the central position of the wafer W toward outside the wafer W so as to trace an arc. At this stage, when the position of the organic solvent component supplying outlet 69a moves approximately half the distance of the radius of the wafer W from the central position of the wafer W, the control device 7 controls the elevating mechanism 64 so that the blocking member 70 moves down and the distance between the surface of the wafer W and the opposed surface of the blocking member 70 opposed to the wafer W becomes 5 mm to 10 mm for instance. In other words, the distance between the surface of the wafer W and the opposed surface of the blocking member 70 opposed to the wafer W is set stepwise so that the blocking member 70 descends more than where the organic solvent component supplying outlet 69a is located at above the central position of the wafer W. The arm 62 is then moved until the location of the organic solvent component supplying outlet 69a reaches the periphery of the wafer W (Step S5).

This supplies IPA vapor to the liquid film of the deionized water formed on the surface of the wafer W, and dissolves the IPA component into the liquid film of the deionized water. At this stage, the atmosphere above the location of the organic solvent component supplying outlet 69a is blocked off by the blocking member 70, which prevents the air flow which develops by the rotation of the wafer W from blowing away the IPA vapor from the vicinity of the surface of the wafer W and secures efficient supply of the IPA component to the liquid film of the deionized water. The IPA component therefore gets efficiently dissolved in the deionized water and the surface tension of the deionized water sufficiently drops down. Since this reduces the surface tension of the deionized water which has entered into inside between patterns which are formed on the surface of the wafer W, it is possible to dry the wafer W while adequately preventing destruction of the patterns.

It is further possible to better dissolve the IPA component in the liquid film of the deionized water which is on the surface of the wafer W, since dispersion of IPA vapor discharged from the organic solvent component supplying outlet 69a is better suppressed due to stepwise reduction of the space between the blocking member 70 and the wafer W which occurs as the organic solvent component nozzle 69 moves from the central position of the wafer W toward the periphery. It is thus possible to maintain a uniform amount of the IPA component which is dissolved in the liquid film of the deionized water per unit area all over the surface of the wafer W, and hence, to evenly dry the entire wafer while sufficiently preventing pattern destruction.

While the blocking member 70 descends stepwise as the organic solvent component nozzle 69 moves in this embodiment, the blocking member 70 may descend continuously as the organic solvent component nozzle 69 moves.

When the arm 62 reaches the periphery of the wafer W, the control device 7 closes the valve 68 and stops supply of IPA vapor from the organic solvent component supplying outlet 69a. The control device 7 thereafter controls the moving mechanism 63, thereby making the organic solvent component nozzle 69 and the blocking member 70 retract from their positions above the wafer W. Following this, controlling the chuck rotating driving mechanism 11, the control device 7 increases the rotating velocity of the spin chuck 1 up to a predetermined fast rotating velocity (which may for instance be 1000 to 3000 rpm) and rotates the wafer W for a predetermined period (10 sec for instance). In consequence, deionized water which remains adhering to the back surface of the wafer W is drained off due to centrifugal force, and the back surface of the wafer W is dried (Step S6).

The control device 7 thereafter stops the chuck rotating driving mechanism 11 and accordingly stops the spin chuck 1, and further, controls the retaining member driving mechanism 19 to put the retaining members 15 in a released state. Further, in order to secure uninterrupted unloading of the wafer W, the control device 7 controls the splash guard elevating driving mechanism 34 and makes the splash guard 3 retract to the retract position. The substrate transportation robot (not shown) then unloads the processed wafer W from the spin chuck 1 (Step S7).

As described above, according to this embodiment, since the atmosphere above the organic solvent component supplying outlet 69a is covered with the blocking member 70 while IPA vapor is supplied when the gas containing the organic solvent component and deionized water which serves as the rinsing liquid is accordingly dried, the air flow which develops by the rotation of the wafer W is prevented from pushing away the IPA vapor from the vicinity of the surface of the wafer W, which in turn achieves efficient dissolution of the IPA component in the deionized water. Since this sufficiently lowers the surface tension of deionized water which has entered into inside between patterns which are formed on the surface of the wafer W, it is possible to dry the wafer W while adequately preventing destruction of the patterns.

Meanwhile, the Step S1 in this embodiment corresponds to the “substrate holding step” of the invention, the Step S4 in this embodiment corresponds to the “liquid film forming step” of the invention, and the Step S5 in this embodiment corresponds to the “organic solvent component supplying step” of the invention.

Next, a second embodiment of the present invention will be described.

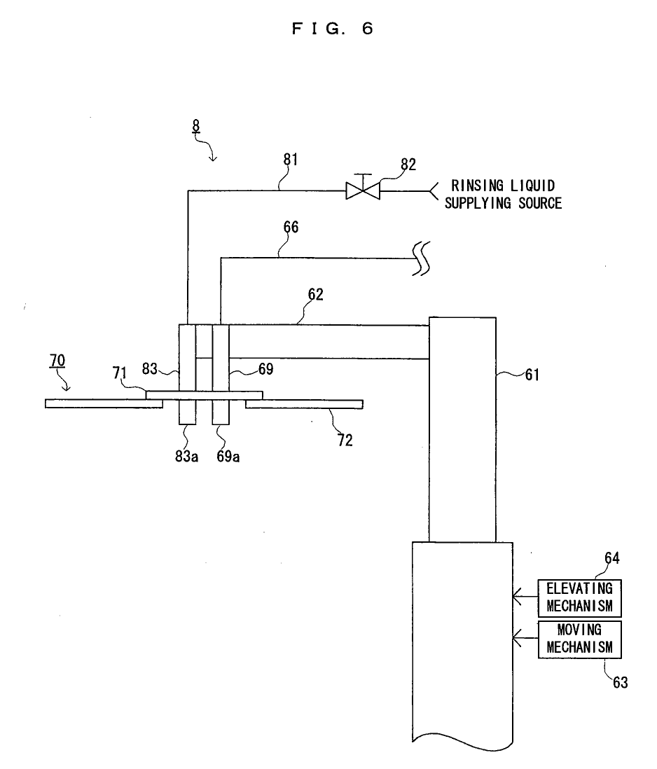

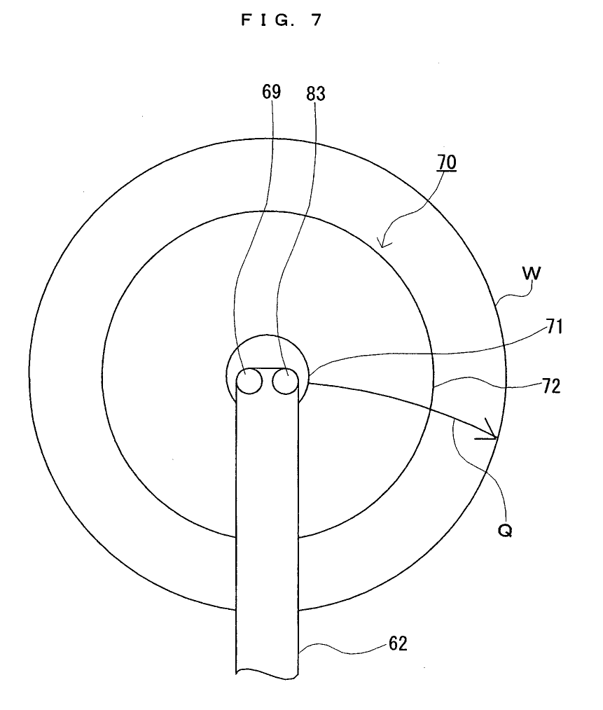

FIG. 6 is a schematic side view for describing the structure of a substrate processing apparatus according to the second embodiment of the invention, and FIG. 7 is a schematic top plan view showing the vicinity of the organic solvent component nozzle. A section around the organic solvent component nozzle is shown in FIG. 6, and portions corresponding to FIG. 1 described earlier are denoted at the same reference symbols.

In the second embodiment, the substrate processing apparatus comprises a rinsing liquid supplying mechanism 8 for supplying a rinsing liquid to the wafer W on the downstream side relative to the organic solvent component nozzle 69 in the scanning direction (which is the direction denoted at the arrow Q in FIG. 7). The rinsing liquid supplying mechanism 8 comprises a rinse nozzle 83, a rinsing liquid supplying pipe 81, and a valve 82. The rinse nozzle 83 is disposed, in the tip end of the arm 62, next to the organic solvent component nozzle 69 on the downstream side in the scanning direction. The rinse nozzle 83 includes a rinsing liquid supplying outlet 83a which discharges the rinsing liquid. The rinsing liquid supplying pipe 81 is connected to the rinse nozzle 83 and supplies the rinsing liquid from a rinsing liquid supplying source to the rinse nozzle 83. The valve 82 is inserted in the rinsing liquid supplying pipe 81 and opens and closes the rinsing liquid supplying pipe 81. Meanwhile, the rinsing liquid supplied from the rinse nozzle 83 may be deionized water for example. Other than deionized water, the rinsing liquid may be functional water such as carbonated water, electrolytic ionized water, hydrogen water and magnetized water, or may be diluted ammonia water (having the concentration of around 1 ppm for instance), diluted hydrochloric acid, etc.

When the arm 62 is pivoted by the moving mechanism 63, the rinsing liquid supplying outlet 83a scans the surface of the wafer W which is held by the spin chuck so as to move ahead of the organic solvent component supplying outlet 69a. Further, the rinsing liquid supplying outlet 83a is arranged so as to leave a gap of about 20 mm from the organic solvent component supplying outlet 69a.

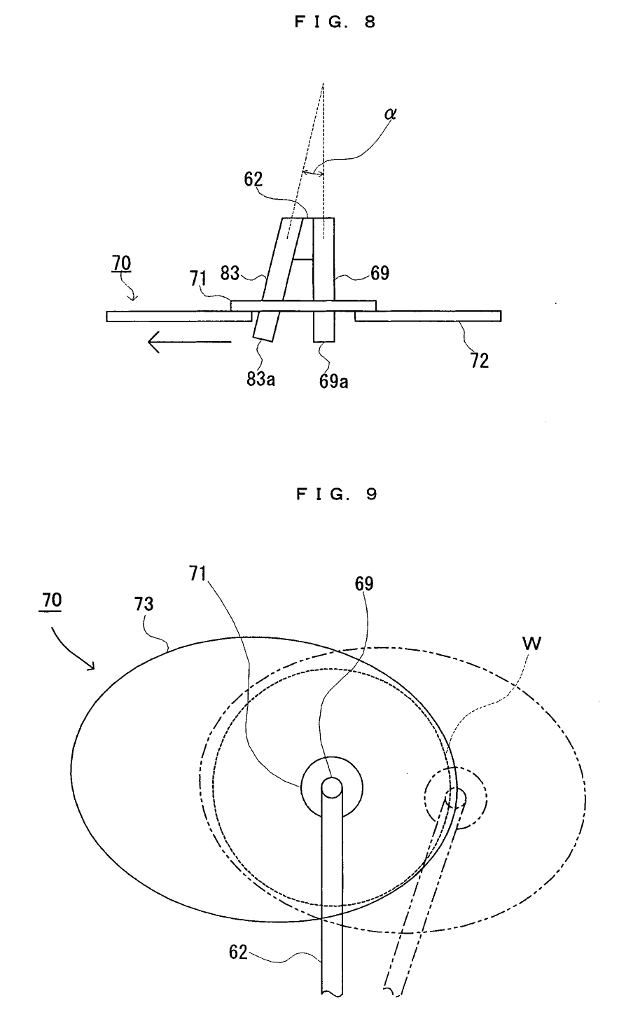

Meanwhile, FIG. 8 is a schematic side view showing a modification of the rinse nozzle. The rinse nozzle 83 may be disposed so that the rinsing liquid supplying outlet 83a is tilted from a vertical direction relative to the wafer W to a scanning direction (denoted at the arrow in FIG. 8) the rinse nozzle 83 scans from the central position of the wafer W toward the periphery of the wafer W (which corresponds to the direction denoted at the arrow Q in FIG. 7). The tilt angle α may for instance be about 30 degrees.

A processing operation performed to the wafer W in the substrate processing apparatus according to the second embodiment is approximately similar to that in the first embodiment shown in FIG. 5. However, there is a difference that while the arm 62 moves at the constant speed at Step S5, the organic solvent component nozzle 69 and the rinse nozzle 83, which is disposed next to the organic solvent component nozzle 69 on the side of the scanning direction of the organic solvent component nozzle 69, move together.

In the second embodiment, after the liquid film is formed at Step S4 and the rinse nozzle 53 is retracted from its position above the wafer W, the control device 7 controls the moving mechanism 63, thereby pivoting the arm 62 so that the organic solvent component supplying outlet 69a is positioned above the central position of the wafer W, and controls the chuck rotating driving mechanism 11, thereby rotating the spin chuck 1 at a predetermined velocity (10 to 100 rpm for instance). The control device 7 then opens the valves 68 and 82 and controls the moving mechanism 63 to move the arm 62 at a constant speed (which may for example be a speed of traveling in about 30 seconds from the central position of the wafer W to the outer circumference of the wafer W) so that the organic solvent component nozzle 69 and the rinse nozzle 83 move toward outside the wafer W. Thus, deionized water is supplied from the rinsing liquid supplying outlet 83a and IPA vapor is supplied from the organic solvent component supplying outlet 69a to the surface of the wafer W which is rotating at a low speed. And the location of the rinsing liquid supplying outlet 83a and that of the organic solvent component supplying outlet 69a gradually move from the vicinity of the central position of the wafer W toward outside the wafer W. The arm 62 is moved until the location of the organic solvent component supplying outlet 69a reaches the periphery of the wafer W (Step S5). Further, with the movement of the arm 62, the location of the rinsing liquid supplying outlet 83a moves ahead of that of the organic solvent component supplying outlet 69a. IPA vapor is thus supplied immediately after replacement of the liquid film of the deionized water formed on the surface of the wafer W with new deionized water freshly supplied from the rinse nozzle 83. Hence, even if silicon is eluted from the wafer W, deionized water containing the eluted silicon is washed away from the surface of the wafer W and the IPA component is dissolved in the new deionized water supplied from the rinse nozzle 83, which attains drying. This suppresses or prevents generation of a watermark.

In addition, since the atmosphere above the organic solvent component supplying outlet 69a is covered with the blocking member 70, the air flow which develops by the rotation of the wafer W is prevented from pushing away the IPA vapor from the vicinity of the surface of the wafer W, which in turn achieves efficient supply of the IPA component to the liquid film of the deionized water. This achieves efficient dissolution of the IPA component in the deionized water and sufficiently lowers the surface tension of the deionized water. Since this reduces the surface tension of the deionized water which has entered into inside between patterns which are formed on the surface of the wafer W, it is possible to dry the wafer W while adequately preventing destruction of the patterns.

Further, the invention may be implemented in other embodiments.

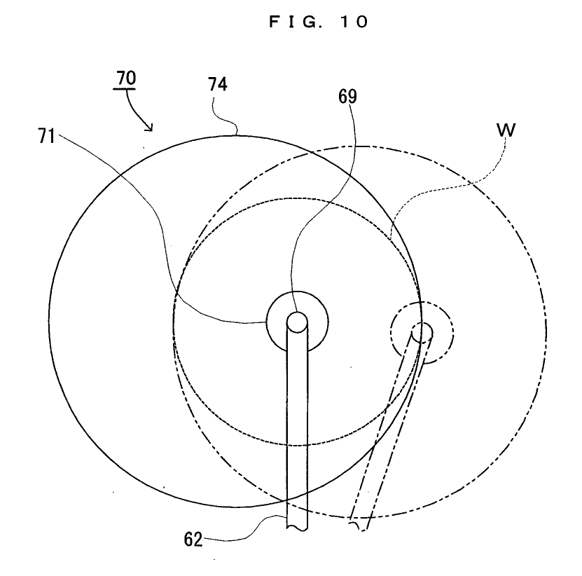

FIGS. 9 and 10 are schematic top plan views of the blocking member for illustrating other embodiments. The blocking members shown in FIGS. 9 and 10 have such sizes which are large enough to always cover the top surface of the wafer W within the range that the organic solvent component nozzle 69, which is driven by the moving mechanism 63, moves from the central position of the wafer W toward the periphery of the wafer W. To be more specific, a plate member 73 of the blocking member 70 shown in FIG. 9 has an oval shape which encompass each one of the two wafers W which have the same shape and are positioned such that their central positions are displaced by the distance of radius of the wafers W from each other. Meanwhile a plate member 74 of the blocking member 70 shown in FIG. 10 has the shape of a circle whose diameter is the sum of the diameter of the wafer W and the distance (that is, approximately the radius of the wafer W) which the organic solvent component nozzle 69 moves. Since these structures ensure no exposure of the liquid film of the rinsing liquid formed on the surface of the wafer W to the ambient atmosphere during drying by means of supply of the organic solvent component, it is possible to prevent oxygen contained in the ambient atmosphere from getting dissolved in the liquid film of the rinsing liquid. Although dissolution of oxygen in the rinsing liquid could result in a watermark, according to these structures, the liquid film of the rinsing liquid formed on the surface of the wafer W is blocked off by the blocking member 70 against the ambient atmosphere, generation of a watermark is further suppressed or prevented.

Further, in the first and the second embodiments described above, although the arm 62 moves at the constant speed when the organic solvent component nozzle 69 moves at Step S5, the arm 62 may move at a varying speed while traveling from the central position of the wafer W toward the periphery of the wafer W. To be more specific, the control device 7 may control the moving mechanism 63 so that the organic solvent component nozzle 69 move faster in the vicinity of the central position of the wafer W than in the vicinity of the periphery of the wafer W. According to this modification, it is possible to maintain a uniform amount of the organic solvent component which is dissolved in the liquid film of the rinsing liquid per unit area all over the surface of the wafer W, and hence, to evenly dry the entire wafer W while sufficiently preventing pattern destruction.

In addition, in the first and the second embodiments described above, the organic solvent component nozzle 69 is disposed so as to discharge the gas containing the organic solvent component toward below approximately in the vertical direction. However, the organic solvent component nozzle 69 may be disposed so that the lower end (that is, the end of the side of the organic solvent component supplying outlet 69a) is tilted (about 10 degrees or less for instance) from a vertical direction relative to the wafer W to the scanning (moving) direction, the upper end of the organic solvent component nozzle 69 being as a supporting point.

The substrate-to-be-processed is not limited to the wafer W but may be other types of substrates such as a glass substrate for a liquid crystal display device. Further, design modifications are possible within the claimed scope of the invention.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing apparatus, comprising:
a substrate holder which rotates a substrate while holding the substrate approximately horizontally;
an organic solvent component supplying mechanism which includes an organic solvent component supplying outlet for supplying a gas containing an organic solvent component to the substrate which is held by the substrate holder and of which a liquid film of a rinsing liquid for washing away residuals adhering to the substrate is formed on a top surface;
a moving mechanism which moves the organic solvent component supplying outlet from an approximate rotation center of the substrate which is held by the substrate holder toward a periphery of the substrate; and
a blocking member which is disposed above the organic solvent component supplying outlet, moves, driven by the moving mechanism, together with the organic solvent component supplying outlet, and blocks off an atmosphere above the organic solvent component supplying outlet.

2. The substrate processing apparatus of claim 1, wherein
the blocking member includes an opposed surface which is opposed to the top surface of the substrate which is held by the substrate holder, and
the opposed surface is parallel to the top surface of the substrate.

3. The substrate processing apparatus of claim 2, wherein a size of the opposed surface of the blocking member is not smaller than an area of the liquid film of the rinsing liquid which is pushed away from the top surface of the substrate by the gas containing the organic solvent component when the gas containing the organic solvent component is discharged from the organic solvent component supplying outlet toward the liquid film of the rinsing liquid formed on the top surface of the substrate.

4. The substrate processing apparatus of claim 3, wherein the size of the opposed surface of the blocking member is smaller than that of the top surface of the substrate which is held by the substrate holder.

5. The substrate processing apparatus of claim 1, further comprising an elevating mechanism which moves the blocking member downward as the organic solvent component supplying outlet moves from the rotation center of the substrate toward the periphery of the substrate.

6. The substrate processing apparatus of claim 5, wherein the elevating mechanism moves the blocking member downward in a stepwise fashion as the organic solvent component supplying outlet moves from the rotation center of the substrate toward the periphery of the substrate.

7. The substrate processing apparatus of claim 1, further comprising a rinsing liquid supplying mechanism which includes a rinsing liquid supplying outlet which is disposed next to the organic solvent component supplying outlet on a downstream side in a moving direction of the organic solvent component supplying outlet, moves, driven by the moving mechanism, together with the organic solvent component supplying outlet, and supplies the rinsing liquid to the substrate which is held by the substrate holder.

8. The substrate processing apparatus of claim 1, wherein a size of the opposed surface of the blocking member is such that the opposed surface always covers the entire top surface of the substrate within a range which the organic solvent component supplying outlet, driven by the moving mechanism, moves.

9. The substrate processing apparatus of claim 1, wherein the moving mechanism reduces a speed at which the organic solvent component supplying outlet moves, as the organic solvent component supplying outlet moves from the rotation center of the substrate which is held by the substrate holder toward the periphery of the substrate.

10. The substrate processing apparatus of claim 1, wherein the organic solvent component is isopropyl alcohol.

11. A substrate processing method, comprising:
a substrate holding step of holding a substrate approximately horizontally and rotating the substrate;
a liquid film forming step of supplying a rinsing liquid to the substrate and forming a liquid film of the rinsing liquid on a top surface of the substrate; and
an organic solvent component supplying step, which is executed after the liquid film forming step, of supplying a gas which contains an organic solvent component to the substrate and moving a supplying position at which the gas containing the organic solvent component is supplied to the top surface of the substrate from an approximate rotation center of the substrate toward the periphery of the substrate, wherein
at the organic solvent component supplying step, a blocking member blocks off an atmosphere above the supplying position at which the gas containing the organic solvent component is supplied to the top surface of the substrate.
